(19) United States
(12) Patent Application Publication
(10) Pub. No.: US 2025/0026483 A1
(43) Pub. Date: Jan. 23, 2025

(54) MODULE FOR AIRCRAFT COMPRISING A DIHYDROGEN PROCESSING SYSTEM

(71) Applicant: Airbus Operations SAS, TOULOUSE (FR)

(72) Inventors: Jérôme MILLIERE, TOULOUSE (FR); Lionel CZAPLA, TOULOUSE (FR); Romain JOUBERT, TOULOUSE (FR)

(21) Appl. No.: 18/776,566

(22) Filed: Jul. 18, 2024

(30) Foreign Application Priority Data
Jul. 20, 2023 (FR) 2307801

(51) Int. Cl. B64D 37/30

(52) U.S. Cl. CPC B64D 37/30

(57) ABSTRACT

A module for an aircraft, the module comprising a sealed housing comprising walls delimiting an interior volume, a processing system intended to process dihydrogen fixed on the inside of the sealed housing and filling elements filling at least in part the interior volume around the processing system. The filling elements may be foam or beads. Also an aircraft with such a module.

### CROSS-REFERENCES TO RELATED APPLICATIONS

This application claims the benefit of French Patent Application Number 2307801 filed on Jul. 20, 2023, the entire disclosure of which is incorporated herein by way of reference.

### FIELD OF THE INVENTION

The present invention relates to a module comprising a housing in which is housed a processing system for dihydrogen for supplying an aircraft engine and in which the housing is filled with filling elements, as well as an aircraft comprising at least one module of this kind.

### BACKGROUND OF THE INVENTION

In order to reduce emissions of carbon dioxide (CO₂) from aircraft engines, it is known in the art for dihydrogen to be used as fuel. The aircraft then comprises a dihydrogen tank and at least one engine powered by said dihydrogen through pipelines running in the aircraft between the tank and each engine and on which dihydrogen processing systems such as pumps, heaters and valves are installed.

Safety must be ensured if an incident occurs on the supply line between the tank and the engine. For this purpose, it is known in the art for various safety systems to be installed. Although an arrangement of this kind is effective, it is desirable to limit the volume of dihydrogen that escapes in the event of an incident.

### SUMMARY OF THE INVENTION

An object of the present invention is to propose an aircraft module comprising a housing in which is arranged a dihydrogen processing system, wherein said housing is filled with filling elements allowing the space available for dihydrogen to be reduced in the event of a leak.

To this end, a module for an aircraft is proposed, said module comprising:
a sealed housing comprising walls delimiting an interior volume,
a processing system intended to process dihydrogen fixed on the inside of said housing

and
filling elements filling at least in part the interior volume around the processing system and conforming to the shapes of said processing system.

The presence of filling elements around the processing system means that the space available for dihydrogen in the event of a leak inside the housing is reduced, which limits the amount of dihydrogen that can be present in said housing.

According to a particular embodiment, each filling element takes the form of a foam block attached to a wall on the inside of the housing.

Advantageously, the foam is sealed.

According to a particular embodiment, each filling element takes the form of a bag containing beads.

Advantageously, the beads are sealed.

Advantageously, the beads are glass beads.

Advantageously, the bag is sealed.

The invention also proposes an aircraft comprising a dihydrogen tank, an engine and at least one module according to any of the preceding embodiments fluidically connected between the tank and the engine.

### BRIEF DESCRIPTION OF THE DRAWINGS

The features of the invention mentioned above, as well as others, will become clearer upon reading the following description of an exemplary embodiment, said description being made in relation to the attached drawings, among which:

FIG. 1 is a side view of an aircraft according to the invention,

FIG. 2 is a schematic and sectional representation of a module according to a first embodiment of the invention and

FIG. 3 is a schematic sectional representation of a module according to a second embodiment of the invention.

### DETAILED DESCRIPTION OF THE PREFERRED EMBODIMENTS

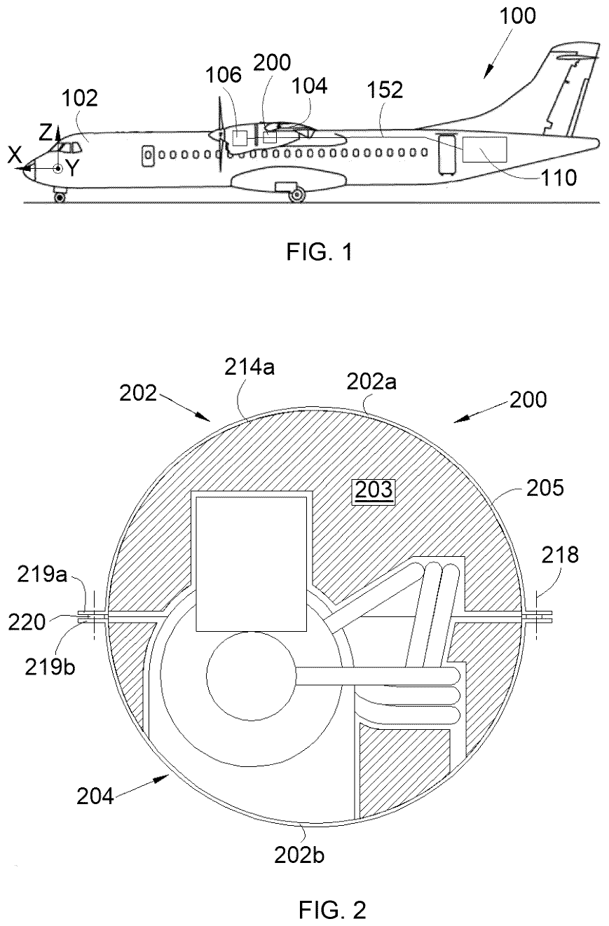

In the following description, terms related to a position are referenced to an aircraft in a normal flight position, that is, as shown in FIG. 1.

In the following description, and by convention, X refers to the longitudinal direction of the aircraft, Y refers to the transverse direction which is horizontal when the aircraft is on the ground and Z refers to the vertical direction which is vertical when the aircraft is on the ground, these three directions X, Y and Z being orthogonal to one another.

FIG. 1 shows an aircraft 100 which comprises a fuselage 102 on each side of which a wing 104 is fixed which carries at least one engine 106 operating with dihydrogen as fuel. In the embodiment of the invention shown in FIG. 1, the engine 106 is a propeller engine, for example, an electric motor powered by a dihydrogen fuel cell, but any other type of engine is conceivable.

Arrow F indicates the forward direction of the aircraft 100.

The aircraft 100 comprises at least one tank 110 in which the dihydrogen is stored, preferably in liquid form. In the embodiment of the invention, the tank 110 is arranged at the rear of the fuselage 102, but a different positioning is possible.

The aircraft 100 also comprises at least one module 200 which is fluidically connected between the tank 110 and the engine 106, in particular by means of a main pipeline 152 which is itself fluidically connected between the tank 110 and the engine 106 to be supplied.

The module 200 is mounted in a sealed manner on the main pipeline 152, meaning that the main pipeline 152 passes through the module 200 from side to side. In the embodiment of the invention shown in FIG. 1, there is only one module 200 but there may be several others arranged one after the other along the main pipeline 152.

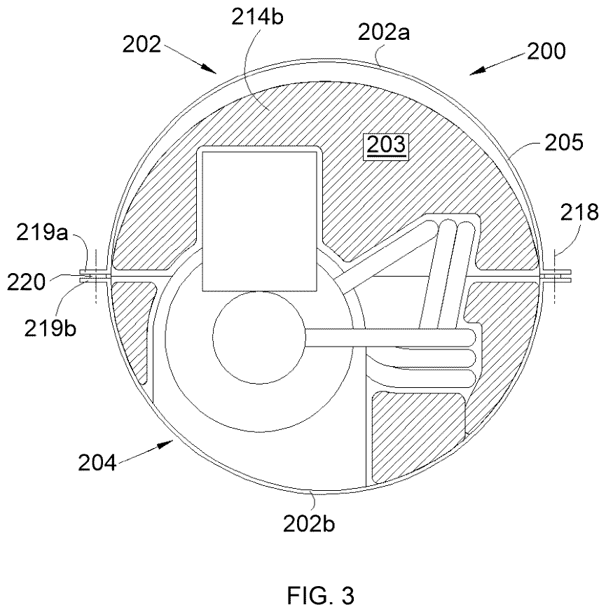

FIG. 2 shows the module 200 according to a first embodiment of the invention and FIG. 3 shows the module 200 according to a second embodiment of the invention.

In the first and second embodiments, the module 200 comprises a housing 202 which comprises walls 205 delimiting an interior volume 203. The housing 202 is sealed to prevent dihydrogen that may be present in the housing 202 from spreading outside the housing 202.

The main pipeline 152 passes through one of the walls 205 from the tank 110 and through one of the walls 205 to reach the engine 106. The passage through each wall 205 of the main pipeline 152 is made in a sealed manner using appropriate means known to a person skilled in the art.

The module 200 also comprises a processing system 204 that processes the dihydrogen flowing in the main pipeline 152 passing through the housing 202. A processing system 204 of this kind is, for example, a pump, a heater or a valve, or other things, or a set of several of these elements, which can be connected by single or double-walled pipes.

The processing system 204 is fixed inside the housing 202, in particular by being fixed to the walls 205 by any appropriate fixing means, such as screw-nut systems, rivets, etc. Alternatively, the processing system 204 may be welded to the walls 205.

Placing the processing system 204 in the housing 202 allows the dihydrogen to be contained in the housing 202 in the event of a leak at the processing system 204.

The housing 202 is filled at least in part with filling elements 214a-b.

Each filling element 214a-b thereby partly fills the interior volume 203 around the processing system 204 and, depending on the degree of filling of the interior volume 203, the space remaining for dihydrogen in the event of a leak is reduced by the same amount. Each filling element 214a-b is an element that has no involvement in the operation of the processing system 204 and has no function other than to fill the interior volume 203.

With an arrangement of this kind, it is therefore easy to fill the housing 202 with filling elements 214a-b limiting the volume available for dihydrogen in the event of a leak.

In the first embodiment of the invention shown in FIG. 2, each filling element 214a takes the form of a foam block which is attached to a wall 205 inside the housing 202, in other words, an inner face of a wall 205.

To best fit the shapes of the processing system 204, the foam block is machined to closely match the contours of said processing system 204.

The foam block is then glued into the housing 202 at appropriate locations.

The foam used is preferably sealed, in order to limit the absorption of dihydrogen by said foam.

The seal of the foam can also be achieved, for example, by covering the foam block with a waterproof film or resin.

In the second embodiment of the invention shown in FIG. 3, each filling element 214b takes the form of a bag containing beads, in particular glass beads, with a diameter of about 30 to 125 micrometers. Each bead is preferably sealed to prevent hydrogen from entering it.

Depending on the space the bead bag needs to fill, the bag can have different shapes adapted to the location at which it needs to be positioned; furthermore, the flexible shape of the bag of beads allows the filling element (the bag and the beads) also to conform to the shapes of the processing system 204.

According to one embodiment, the bag is sealed to prevent hydrogen from entering it.

In the embodiment of the invention shown in FIGS. 2 and 3, the housing 202 is made up of two shells 202a-b fixed in a sealing manner to one another by any appropriate fixing means 218, such as screw-nut systems, rivets, etc.

In the embodiment of the invention presented here, each shell 202a-b has a flange 219a-b extending around the perimeter of the shell 202a-b and is opposite the flange 219b-a of the other shell 202b-a and the fixing means 218 fix the flanges 219a-b together.

To guarantee the seal between the two shells 202a-b, a gasket 220 is arranged between them and, more specifically in this case, between the flanges 219a-b.

In both embodiments, a method of filling the module 200 includes the steps of:
providing the two separate shells 202a-b,
providing the filling elements 214a-b,
placing the filling elements 214a-b and the processing system 204, and
joining and fixing the two shells 202a-b together in a sealed manner.

If the processing system 204 is already delivered fixed to one shell 202b, there is no need to install it during the placement step.

The placement of the filling elements also involves, if necessary, machining the filling elements 214a-b and/or fixing the filling elements 214a-b to one of the shells 202a-b.

During the joining and fixing step, the gasket 220 is also put in place.

Although the filling elements 214a-b are described as either taking the form of a foam block or the form of a bag containing beads, it is possible to use both types of filling elements for the same housing 202.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A module for an aircraft, said module comprising:
a sealed housing comprising walls delimiting an interior volume,
a processing system configured to process dihydrogen fixed on an inside of said housing, and
a plurality of filling elements filling at least a part of the interior volume around the processing system and conforming to shapes of said processing system.

2. The module according to claim 1, wherein each filling element comprises a foam block attached to a wall on the inside of the housing.

3. The module according to claim 2, wherein the foam block is sealed.

4. The module according to claim 1, wherein each filling element comprises a bag containing beads.

5. The module according to claim 4, wherein the beads are sealed.

6. The module according to claim 4, wherein the beads are glass beads.

7. The module according to claim 4, wherein the bag is sealed.

8. An aircraft comprising:
a dihydrogen tank,
an engine, and
at least one module according to claim 1, the at least one module fluidically connected between the dihydrogen tank and the engine.
